(19) United States
(12) Patent Application Publication
(10) Pub. No.: US 2013/0270033 A1
(43) Pub. Date: Oct. 17, 2013

(54) Play Furniture

(71) Applicant: Nancy Hebenthal, Redmond, WA (US)

(72) Inventor: Nancy Hebenthal, Redmond, WA (US)

(21) Appl. No.: 13/833,926

(22) Filed: Mar. 15, 2013

Related U.S. Application Data
(60) Provisional application No. 61/612,361, filed on Mar. 18, 2012.

(51) Int. Cl. G10K 11/00

(52) U.S. Cl. CPC G10K 11/00
USPC 181/175

(57) ABSTRACT

An article of acoustical furniture for use in a child day care center that lowers decibels, minimizes, absorbs, deflects, or aims sound, is suitable for use by all ages, is washable, stable, sturdy and safe for use by children.

### TECHNICAL FIELD

The invention relates to children's play furniture for optimizing acoustics in a learning environment.

### BACKGROUND

Today many children spend more of their awake time in a day care facility than at home. Day cares can be very loud. Excessive noise can adversely affect a child's hearing, language development, ability to learn, social interactions and overall well-being. There are appropriate times for high noise volume, and times when lower volume is necessary throughout a child's day. In my experience, as both a preschool teacher and a mother, most day care center design does not take this into consideration. Few states have laws or guidelines regarding this, and those that do are very vague.

Acoustics is the science of sound, including its production, transmission, and its effects on people. Sound is something that can be heard. It is produced by rhythmic vibrations, called sound waves, moving through air or other mediums. One complete sound wave is called a cycle. In FIG. 11 sound waves pass back and forth past a neutral position. FIG. 11 shows one cycle, measured as 1 hertz.

Frequency equals how many cycles are completed in one second, measured in hertz (Hz). One Hz=one cycle. The size of the wave length, and how far it swings away from a neutral position, determines the sounds pitch and intensity. FIG. 12a-b shows this. In FIG. 12a two waves have the same frequency, but different amplitudes. The upper is quiet, the lower is louder. In FIG. 12b two waves have the same amplitudes, but different frequencies. The upper is low pitch, the lower is high pitch.

The intensity of sound is measured in decibels (dB). The higher the decibel, the louder the sound, or amplitude. Decibels can be manipulated by use of reflective or sound absorbent material, the shape, and form of these materials and/or building structures. Frequencies cannot be manipulated. For every 10 decibels, the intensity of the sound is ten times louder than the previous. For example, 20 dB is ten times as loud as 10 dB, and 30 dB is ten times louder than 20 dB. To give a basic idea of sound levels on a decibel scale, zero is the least perceptible sound. Human breathing is at about 10 dB and speech is between 50 and 70 dB. Decibels between 60 and 80 are considered to be loud, and long term exposure to 80 dB and above can cause hearing loss. Sound at about 130 dB can cause pain. To see average decibel levels for other common sounds, refer to Egan, David M., Architectural Acoustics, McGraw-Hill Book Company, 1988.

Perception to sound and sensitivity to sound and noise is unique to each individual. It is dependent on hearing ability, frequency, “time of occurrence, duration of sound, and psychological factors such as emotions and expectations” (Architectural Acoustics, 1988). Noise is unwanted sound. Any noise that is abrupt, intermittent, or fluctuates widely can be extremely annoying. Human hearing is generally less sensitive to low frequency sound. Changes in decibel levels at about 6 dB and above are clearly noticeable. It is hard for humans to disregard sound that contains speech or music.

The US Department of Labor established the Occupational Safety and Health Administration (OSHA) in 1970. OSHA's mission is “to ensure safe and healthful working conditions for working men and women by setting and enforcing standards” (http://osha.gov/about.html). OSHA enforces regulations to protect against hearing loss caused by exposure to noise in the workplace. They have established how long a person can be exposed to particular decibels in a given day. The decibels are “A” weighted, which means they are measured by an instrument that measures sound levels at the frequency of human ears, and are noted as dBA. Since then, other health organizations have adopted similar charts. See FIG. 14 Safe Decibel Exposure Time.

White noise, noise that is produced by combining sounds of all different frequencies together, is often used to mask other sounds because your brain cannot pick out just one sound to hear or listen too. It is often used in offices and other situations where privacy is an issue. However, white noise can sometimes be annoying to those that are sensitive to sound.

When sound strikes the surfaces of a room, part of the energy is absorbed, and part of it is reflected back into the room. Depending on the structures intended use, the amount of sound absorbed or reflected can influence the experience. The amount of sound a material absorbs is referred to as a absorption coefficient. A zero coefficient means that no sound is absorbed. Materials that absorb all of the sound have the highest rating, a coefficient of one.

You can reduce the decibels by using sound absorbing materials. These materials are porous, trapping the sound waves in tiny air-filled spaces where they bounce around until their energy dies. Examples of sound absorbing materials are drapery, clothing, fibrous ceiling tiles, and carpet.

The effectiveness of the material used for absorption is based on the physical thickness, density, porosity, fiber diameter, and orientation. The internal structure must have interconnected pores to be highly effective. An easy way to test if a material can be an effective sound absorber is to blow through it. If the material is thick and air passes with moderate pressure, it should be a good absorber.

In addition to wall, ceiling, and floor treatments, you can manipulate sound by adding baffles and clouds to the room. Both are very effective sound absorbers that work well to reduce reverberation and increase speech intelligibility. Baffles are vertical panels in which all edges and sides are exposed, placed in specific areas of the room. They work best when spaced apart. Clouds are horizontal baffles, which work in the same way. Both can be fixed in place, or movable to accommodate different functions in multi-purpose spaces.

Hard, dense surfaces such as wood, tile, and concrete, reflect more sound than they absorb. There are times when this is favorable, such as sporting events when you want the crowd to be excited, or in a concert hall, where you want the sound to reverberate in a controlled manner.

The shape of a room, baffles, diffusers, etc., along with the angle of its form, affect the way sound travels throughout a space. Sound reflects, distributes, and reverberates off different shapes and angles in different ways, and will effect the way in which the sound is distributed and received by the listener. A domed ceiling, for example, can create a whispering gallery effect. This is when a person at one corner can whisper, and the person in the opposite corner will hear clearly, while a person standing only a few feet away from the speaker cannot hear. The shape allows the sound energy to reflect along the domed ceiling surface. (See FIG. 15) The whispering effect can be avoided by using a sound absorption liner. Baffles or clouds can be used to either absorb or redirect the sound, depending on the material they are composed of, and the angle in which they are hung.

The intended purpose of the room will dictate how the room is shaped, and the forms within it For example, in an auditorium, a flat ceiling reflects sound from the stage in the front to the back with only one useful reflection. (See FIG. 16)

By contrast, a sloped ceiling increases the amount of sound reflection so that the middle and rear seats receive reflections from both the ceiling planes, improving audibility throughout the auditorium. (See FIG. 17)

Infants and children hear differently than adults. Children's hearing is very sensitive. Even though their inner ear is fully developed at birth, their ear canal is still very small. In turn, the sound entering into the canal has less room to develop, causing it to become much louder. Sound can be as much as 20 dB louder for infants than for adults, creating a greater chance for damage from loud noises. Auditory development continues into adolescence, progressing through three stages. The first stage happens from birth through 6 months, the second from 6 months to 5 years, and the third stage from 5 years through adolescents. These stages make it more difficult for children than adults to hear the details of speech, to learn, and comprehend in noisy conditions. They emphasis the need for acoustically sound environments for infants and children to learn in.

Stage one, maturing of sound coding, happens from birth through 6 months. During this time, the middle ear is less efficient than an adults in transmitting sound to the inner ear. The transmission of sound through the inner ear to the brainstem is still developing. Their ability to differentiate frequencies is immature, especially high frequencies. Sound transmission through the middle ear improves greatly the during the first year, then continues at a slower pace through adolescents.

Stage two, selective listening and discovering new details in sound matures between the ages of 6 months to 5 years. At six months the middle ear is much more efficient and the brain stem transmission has matured. During the age bracket of 6 months to 5 years, infants and children listen to all frequencies, while adults listen to the most useful. This makes it difficult for them to distinguish between target sounds and background noise, which in turn makes it hard for them to hear a target sound.
This finding implies that learning about sound will be more difficult for infants and preschool children in noisy environments and those in which there are several competing sources of sound . . . . The development of selective listening involves not only picking out one sound among several, but also listening to the details in complex sounds such as speech. (Lynne Werner, 2007)

Stage Three, the maturing of perceptual flexibility takes place from 6 years through adolescents. By age 6, children are able to focus on useful parts of sound, and are not as influenced by background noise. However, the presence of noise or reverberation can make it difficult for a child to hear specific aspects of speech, even if an adult is able too. For children to hear in noisy situations, it requires more attention and processing, and many of them cannot manage this, since the ability to process in high levels of background noise is not yet fully developed.

### Affects of Noise on Children

The study of psychology and acoustics combined is called psychoacoustics, which studies the response of humans to sound. They define noise as “unwanted sound”. (Noise and Hearing Loss, OSHA, 1997-2010) What exactly makes a sound noise is different for each individual. Noise that is pleasant to some, is annoying to others.

There are times when noise is appropriate, and can stimulate wanted behavior, such as at sporting events, during exercise, and at times when enthusiastic participation is desired. However, noise can also stimulate unwanted behavior, affect physical and emotional health, and affect the way in which a child learns and develops. Noise also makes verbal communication harder, and sometimes impossible.

### Physical and Emotional Affects of Noise

The most noticeable physical affect of noise is on hearing ability. It can be a temporary problem, such as at a concert, or permanent. Damage to hearing occurs in two ways. Brief exposure to extremely loud sounds, like a firecracker may cause instant damage. The second is by consistent exposure to moderately loud levels of sound, (over 80 dB), that over time wear out the tiny hair cells in the inner ear. These hair cells are the nerve receptors for hearing. Signals from them are translated into nerve impulses that are sent to the brain. They do not have the ability to repair themselves, so damaging them causes permanent loss of hearing.
The number of Americans age 3 and older with some form of hearing disorder has more than doubled since 1971 (according to the National Institute on Deafness and Other Communication Disorders). US government survey data revealed that 12.5% of children ages 6 to 19 (approximately 5.2 million children) have permanent damage to their ears' hair cells caused by exposure to loud noises. (www.childrenshearing.org)

Noise can also cause an upset stomach, increase breathing rate, increases blood pressure, and make it difficult to sleep, even after the noise stops. When verbal communication competes with noise, it can strain the vocal cords.

Emotionally, noise can cause fatigue, irritability, stress, and nervousness. All of these can have an adverse affect on our ability to perform tasks and to pay attention. They may adversely affect our behavior towards ourselves or others. Excessive noise can cause a child to become withdrawn, feel overwhelmed, or over stimulated. It can cause a child to feel insecure or scared.

### Noise Affects a Child's Learning and Development

Noise affects the way a child hears sounds, and speech. When their environment is loud, they have a difficult time hearing and/or distinguishing sounds and words that are new to them, or that they are unfamiliar with. This adversely affects their communication skills, and reading skills, as well as their cognitive skills

Noise may also affect a child's ability to focus on the task at hand. Even when they appear to be playing or working on a particular task, background noise can affect how much they are really understanding in relationship to what they are doing, and cause their thoughts to wonder. It can also affect their ability to make choices, cause confusion, and misunderstanding, as well as affect a child's social interaction.

### Recommended dBA Levels for Schools

Although current research shows that noise levels in schools are a detriment to children's learning and overall well being, there are no US government regulations in place regarding this issue. However, in 1998 the US Access Board joined with the ASA to develop an acoustic classroom standard. The work has been accredited by the ANSI, and is known as the “ANSI/ASA SR.60-2010 American National Standard Acoustical Performance Criteria, Design Requirements, and Guidelines for Schools, Parts 1 and 2” sets specific criteria for maximum background noise at 35 dBA and a reverberation time for unoccupied classrooms at 0.6-0.7 seconds. It is voluntary unless referenced by a state code. (http://www.access-board.gov/acoustic/index.htrn)

Washington State Licensing Standards for Day Care Centers states that “The licensee shall maintain a safe and developmentally appropriate noise level, without inhibiting normal ranges of expression by the child, so staff and child can be clearly heard and understood in normal conversation”. (Daycare.com/Washington/index47.html) This standard has no specific dBA to guide the design of the school.

### DISCLOSURE

I have read books, researched acoustics, and met with an acoustical engineer/designer to gain a basic understanding of sound and noise. I have learned how various design aspects, such as shape, form, size and materials, effect sound, the way it travels through space, and the various ways it can affect people. I have researched 2 built environments: an ancient Greek theatre and Benaroya Hall in Seattle, Wash.

I have researched and gained basic knowledge of how the human ear works, how children hear, and the effects of noise on children. I visited three child day care facilities and noted activities and decibel readings.

Using the knowledge I gained through my research, my next step was to design, build, and test furniture. I chose the child care center here on Bellevue College campus to further my decibel reading study and test my furniture. My design process included many sketches, building small scale models as well as full scale models and prototypes, and then building the final designs. I then installed the final designs at a child day care center and took decibel readings. These decibel readings were compared to the initial readings to see if my designs were successful at lowering the sound level of the classroom.

I completed four designs, including a toy shelf, a multipurpose chair/easel, a stealth style floor leaning surface/cave, and a bench/tunnel

### Case Study 1: Ancient Theatres

### Project Information:

The Greek theatre at Epidaurus (See FIG. 18) built in the fourth century B.C.
Question: Why does a spectator sitting in the last row hear the music or person speaking on the stage as clearly as the spectator in the front?

### Vocabulary:

Auditorium: seating area for spectators.
Orchestra: the playing area
Skene: stage house. Purpose was to hide the actors from the spectators, dressing rooms, and prop rooms
Paraskeia: long, high walls that extended on both sides of and parallel with the Skene.
Koilon: tiered seats of a theatre
Acoustic diffraction: the bending or flowing of a sound wave around an object or through an opening
Frequency: the rate at which sound waves travel (vibrate) per second, measured as hertz.

### General Information on Greek Theatres:

built on steep hillsides in rural locations
seating
a. in a semicircle around the stage, called the orchestra, to keep the audience close to the scene
b. steep rise of greater than 20 degrees
c. provided good site to the stage
d. permitted reflected sound energy from the stage floor
e. reduced attenuation (reduction of sound energy as it travels) caused by the seated audience
f. backs and risers sloped backward by approximately 10 degrees general beliefs/theories of why acoustics worked so well
a. actors wore masks with conical-shaped megaphones built into the mouths
b. wind direction generally blew in the direction from the stage towards the audience
c. the slope of the seat rise
d. the skene provided sound reflection
e. the semi-circle or oval shape of the theatre

### Theatre at Epidaurus

In January of 2007, acoustic and ultrasonic expert Nico Decloercq and engineer Cindy Kekeyser researched the acoustics of the theatre at Epidaurus. They found that previous theories of why the back row heard as well as the front row are not accurate. They experimented with ultrasonic waves and numerical simulations of the theatre's acoustics. They discovered that it is the limestone structure and seats created the exceptional acoustics.

In an open amphitheatre, various frequencies of sound diffract off the ascending corrugated material of the limestone and reflect off the walls of the Koilon and the skene. But only certain frequencies, above about 500 hertz, are scattered and heard. The limestone acts as a filter for low frequency (below 500 hertz) sound waves. This means that the murmur of the crowd, the noise of the wind, and other low frequency sounds are quieted, allowing the higher frequencies of the music or the voices from the stage to travel farther. It does not however, make them louder.

Since the human voice consists of both high and low frequencies, the brain reconstructs the missing low frequencies through virtual pitch, which helps fill in the incomplete sound.

This discovery could be the reason that the acoustics of the theatre of Epidaurus was never duplicated, although attempted many times Other theatres used different seating materials, such as wood benches, that do not have the acoustical properties of the limestone.

### Relevancy to Disclosed Technology on Acoustics

I researched the ancient theatre at Epidaurus to see what it was that made it acoustically superb. I assumed it was the shape and was interested in finding out what role the shape of the theatres played in the acoustics. While I did find out that semicircle shape was preferred for theatres over the oval because of the way sound echoes, or resonates back and forth, before dissipating in the ovals. The open shape of the semicircle with the open end prevents this. I was surprised that the limestone was the key to the acoustics. I had always assumed that since stone was hard, it would be reflective of sound and cause it to be loud. It never occurred to me that the porousness of stone could actually absorb sound, and help with clarity and hearing. This makes me more curious as to what other stone or hard surfaces my help control acoustics. It will give me another option in choosing materials that are suitable for use in day care facilities when I am making my suggestions for acoustical materials.

### Case Study 2: Benaroya Hall

Benaroya Hall, Home to the Seattle Symphony, 200 University St. Seattle, Wash. 98101
Designers: LMN Architects; Acoustical Consultant: Cyril M. Harris, PH.D. Date of Construction: The design phase began in 1986, with construction completed in 1998.

The 2,500 seat main performance hall, known as S. Mark Taper Foundation Auditorium, was designed for the sole purpose of the performance of the Seattle Symphony. With this in mind, the design had to integrate the best musical acoustics possible and the richness expected of a symphony hall. This was accomplished by the combined use of form and materials to construct the hall.

The smaller, 540-seat Illsley Ball Nordstrom Recital Hall corresponds with the qualities of the main auditorium. It is designed for smaller ensemble and solo performances, as well as those by community-based organizations.

The rectangular form of the auditorium envelopes other acoustically significant forms, consisting of triangles and inverted pyramids. The triangular forms are various sizes, have faceted planes, and are slanted. The inverted pyramids are placed on the ceiling These forms reflect and diffuse the sound back toward the audience. Wood veneer on the walls is divided into smaller sections, each one a different size, with the fasteners placed precisely so that each panel resonates with its own unique frequency of sound. Each panel is fastened with unique fastener placement; no two panels are fastened in the same order. This combines for a well-balanced reverberation time, mixture of tones, and an even decay of sound. (See also FIG. 19, S. Mark Taper Foundation Auditorium)

“Orchestral performances require long reverberation times, which require surfaces that are heavy and dense to reflect sound and absorb as little as possible.” (Benaroya Hall web site) Therefore, the materials used to construct the auditorium consist of concrete, plaster, wood, and cast glass. The main structure is concrete. The balconies are constructed of a cast concrete base, with a heavy plaster overlay. The wood veneer on the walls and doors is 1/40 of an inch and placed on particle board, for a combined depth of ¾ inch. Fiberglass inserts are placed between the concrete, wood veneer, and furring strips. The fiberglass is ¼ inch thicker than the furring strips so it will compress when the veneer panel is set in place. The light fixtures are cast glass which are heavy and very thick to insure that will not resonate with sound.

The smaller Illsley Ball Nordstrom Recital Hall is designed with the similar triangular forms that diffuse sound. The wall forms are cast concrete with plaster overlay. The floors and the stage are wood.

The acoustical qualities of the combined shapes and materials become an important part of the architectural design, and account for the overall exceptional quality of sound in the auditorium. All of these together combine for the balanced reverberation for all frequencies of the music being played, as well as the ability of them to diffuse sound. (The time it takes to hear the sound before it fades, and how the sound is distributed.)

The precise layout, the surfaces of the triangular forms, the sharpness of the edges, and the angles of the planes combine to reflect the sound at straight angles, as opposed to a curved, rounded wall which scatters sounds. The various placements of the angles allows for controlled sound distribution throughout the auditorium, allowing the tones of each instrument to evenly mix through the air, and allowing us to hear them combined as music. There is very little in the auditorium that absorbs the sound. The relatively small amount of fiberglass insulation absorbs the little vibration of the wood panels.

### Case Study 3

### Noise in Day Care Centers

I visited 3 day centers. I spent an average of 2 and ½ hours at each, taking decibel readings and noting activities. The age of the children were older 3 year olds and 4 year olds, together in one class room. Each class had two instructors.
Center 1: 19 children, mostly closed room, with doors open to stairs going to an upper and lower floor, and adjacent to a toddler room with open doors.
Center 2: 11 children, mostly closed room, open doors to the hall, 8 ft. walls open above, with a ceiling height of about 12 feet.
Center 3: 18 children, totally enclosed room, with 3 small decorative fabric items hanging from the ceiling, and some other craft-type items hanging (a paper mache solar system).

At centers 1 and 3, there were 19 and 18 children in the room. At center 2, there were 11. This made a significant difference in the decibel readings. Center 2 with the fewer children had readings from 66 dBA to 86 dBA, with an average decibel reading of 78 dBA. Center 1 with 19 children had decibel readings between 70 dBA and 106 dBA, with an average of 86. Center 3 with 18 children had decibel readings between 60 and 102, with an average of 82. The rooms were quietest during story time with readings of around 60 and 76, varying on the voice of the reader, and the children's interaction. They were the noisiest at free time, with the block area being the loudest topping out at 98 dBA at both centers 1 and 3.

Center 1 had tall bookshelves dividing the play centers, a few very thin rugs on the floor, curtains on 2 windows that were rolled up. The noise between in the play areas enclosed by the book shelves were about 6 to 10 dBA louder than the areas that were open, such as at the tables were children were coloring or doing art projects.

Center 2 had medium height or lower book shelves creating areas, but less of them. They were mostly lining the walls. Center 3 also had medium height to lower book shelves creating area. The room was about the same square footage as at center 1, but the floor plan was different, with larger play areas.

My observation at this point tells me that the higher book shelves had a higher decibel reading than the areas with the lower shelves, which allowed some of the sound to escape over them, rather than trap the sound totally. The area in center 3 that had shelving with a perforated back had slightly lower decibel readings, around 4 dBA lower, than the areas with same height shelf, with a solid, white board/magnetic backing Note that the activities were different, but it was still during free time with active activities.

The behavior of the children in center 1 was more aggressive than the other two centers, with children knocking down others blocks, arguing over magnets and other toys, occasional children yelling, and very loud voices at all of the centers. The number of children was limited in each area, but in both the block and magnet area, children were arguing over who got to stay there and play. The teachers kept there voices calm while working with the children, although seemed to be a bit agitated by the end of the morning The general atmosphere of the room was cluttered and the play areas felt enclosed. You could constantly hear a drone-like sound of toddler activity in the adjacent rooms. There was also low, but nearly constant sound of foot steps from the floor above, at times loud stomping.

The behavior of the children in centers 2 and 3 was much more easygoing. There was very little arguing between the children, they seemed calm for the most part, except the occasional excitement of accomplishing a floor puzzle or knocking down of a block building. The atmosphere at both of these rooms was more open, and less cluttered, with ample room for the children at all of the centers, except the block area. The teachers in these two centers remained calm and showed no signs of fatigue or agitation by the end of the morning

I conclude that both centers 1 and 3 could benefit from some acoustic design elements. With the average decibel readings about the safe 80 dBA mark, there is a chance for these children to develop some hearing damage over time caused by repeated exposure to mid-high range decibels. As far as the overall design of the rooms, center 1 could benefit from lower shelving, better quality rugs, and a more open floor plan in the play areas, especially the magnet area and the block area. This would help the reverberation of sound in these areas, and the overall acoustic quality of this room. Center 3 could benefit from more open-back shelving in the block area.

### CONCLUSION

Noise levels in today's classrooms need improvement. The sound level is so high, that if OSHA regulated them, the children and care givers would need to wear hearing protection most of the day, especially at free play. There are several organizations available, such as the Children's Hearing Center, that will help evaluate the centers needs. If schools would take the information available and use the guidelines at the beginning of the design phase, the cost in the long run would be less then to retrofit to fix the problems later. It is the architects and designers obligation to educate and guide their clients towards a safe and effective learning environment for the sake of our children's health and well being.

There are benefits of sound. Sound enlivens space, and provides energy for those experiencing the space. However, too much noise can cause learning problems, health problems, and hearing impairment. The key is to balance out the good noise with the bad noise.

Use of acoustic materials to make a child's environment safe does not mean you have to pad the walls and floors. It means incorporating form and materials throughout the built environment and the space to allow for noise when appropriate, and quiet when necessary.

If the child care centers owners are not going to use the information available to them about safe noise levels in the classroom to guide in the design of the classrooms, then the government needs to enforce guidelines to protect our children's hearing, overall health and well being, and to help them succeed in learning

### Project Type

What is needed: design acoustical furniture for use in a child day care center, that when combined, lowers the decibels by 20%, minimizes, absorbs, deflects, or aims sound, is suitable for use by all ages, is washable, stable, sturdy and safe for use by children.

For testing, I selected an interior environment of a child day care center, namely Bellevue College Child Day Care Center.

### Review of How Material Effects Acoustics

Hard, solid surfaces reflect sound.
Hard, perforated surfaces both reflect, allow sound to travel through, and trap sound within the perforation points. Example: Peg board
Hard, porous material both reflect and trap sound within the pores. Example: Micor, lime stone, cork
Soft surfaces absorb sound. However, the amount of sound absorbed depends on the density of the material used. The more dense the material, the less sound absorbed. To test the absorbency of a material, simply blow through it. The easier the air travels threw it, the more absorbent it is. Example: Dense foam will absorb less sound then a softer, more porous foam.
Fabric surfaces allows sound to pass through, and/or will absorb or reflect sound, depending on its density. Example: Loose weave burlap with both allow sound to pass through and absorb sound into its fibers. Solid, heavy vinyl will reflect sound, while perforated vinyl will allow sound to travel through, trap sound in the perforations, and reflect some sound.

### SUMMARY

Today many children spend more of their awake time in a day care facility than at home. Day care centers can be very loud. Excessive noise can adversely affect a child's hearing, language development, cognitive skills, social interactions, and overall well-being.

Acoustics is the science of sound, including its production, transmission, and its effects on people. Sound is something that can be heard. Noise is unwanted sound. Perception of sound and noise is unique to each individual. The intensity of sound is measured in decibels. Long term exposure to 80 dB and above can cause hearing loss. Decibel levels can be manipulated by using materials that either absorb or reflect sound. You can manipulate the way sound travels throughout a space using specific materials for your sound specifications, and by shape, form, and angles of structures, baffles, clouds and diffusers.

Children hear differently than adults. Their hearing is very sensitive. Sound can be as much as 20 dB higher for an infant as it is for an adult. Auditory development occurs in three stages which begin when you are born and continues through adolescents. These stages make it more difficult for children than adults to hear details of speech, to learn, and to comprehend in noisy environments. This emphasizes the need for acoustically sound environments for infants and children to learn in.

The study of psychology and acoustics combine is called psychoacoustics, which studies the human response to sound. Noise can stimulate behavior, sometimes for the good, sometimes adversely. It is good stimulation when enthusiastic participation is desired. Noise is adverse stimulation when it brings about unwanted behavior, and poor physical and emotional health. Noise can also have adverse affects on the way a child learns and develops, and their over all well-being.

While there are acoustical standards for classrooms developed by American National Standards Institute (ANSI) and the Acoustical Society of America (ASA), most are for elementary schools and higher education. Compliance with them is voluntary unless referenced by state code.

### BRIEF DESCRIPTION OF THE DRAWINGS

FIG. 1 shows various study models.

FIGS. 2a-b show a bridge/tunnel structure.

FIG. 3 shows a fish shaped book shelf.

FIG. 4 shows a tunnel with interior toy shelf.

FIG. 5a shows leaning post.

FIG. 5b shows a bendable sculpture.

FIG. 6a shows a combination of seat, tunnel, shelf or drawing surface; FIG. 6b is a seating area; FIG. 6c is a shelf/low table area.

FIG. 7a-b shows a listening center.

FIGS. 8a-b show a stealth chair/cave structure.

FIGS. 9a-b show a zigzag chair.

FIGS. 10a, 10b1, 10b2 and 10b3 show a toy shelf.

FIG. 11 illustrates a single hertz.

FIG. 12 illustrates frequency and amplitude variations.

There is no FIG. 13.

FIG. 14 illustrates human decibel tolerances.

FIG. 15 illustrates schematic reflections along a dome.

FIG. 16 illustrates schematic reflections along a flat ceiling

FIG. 17 illustrates schematic reflections along an angled ceiling

FIG. 18 illustrates the theatre at Epidaurus.

FIG. 19 illustrates the Mark Taper Forum.

### DETAILED DESCRIPTION

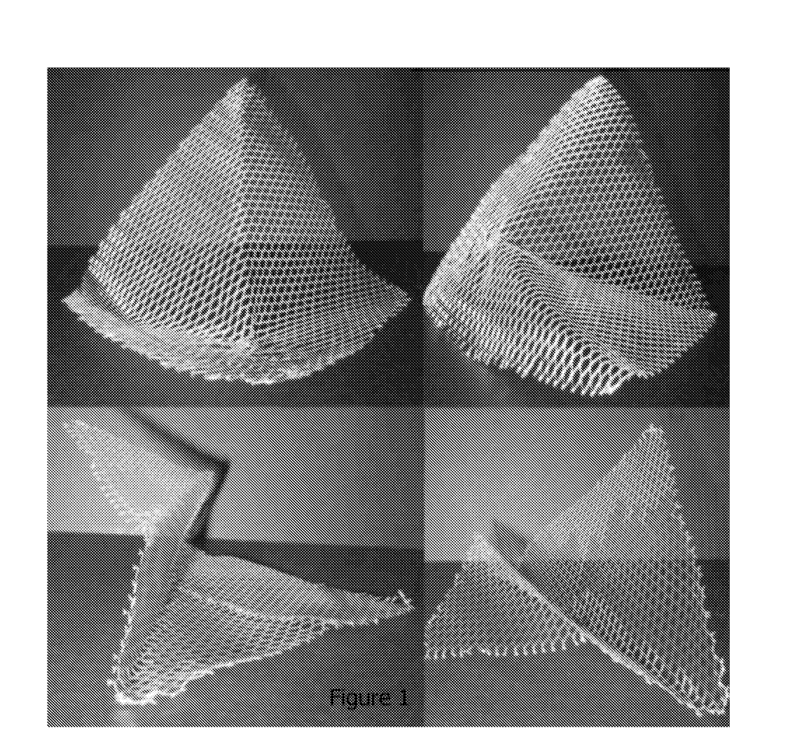

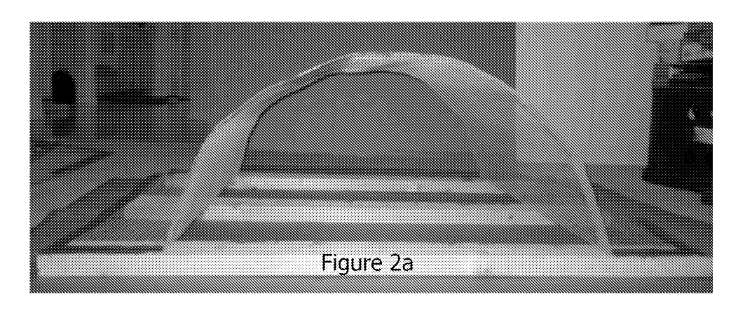

FIG. 1 shows various study models.

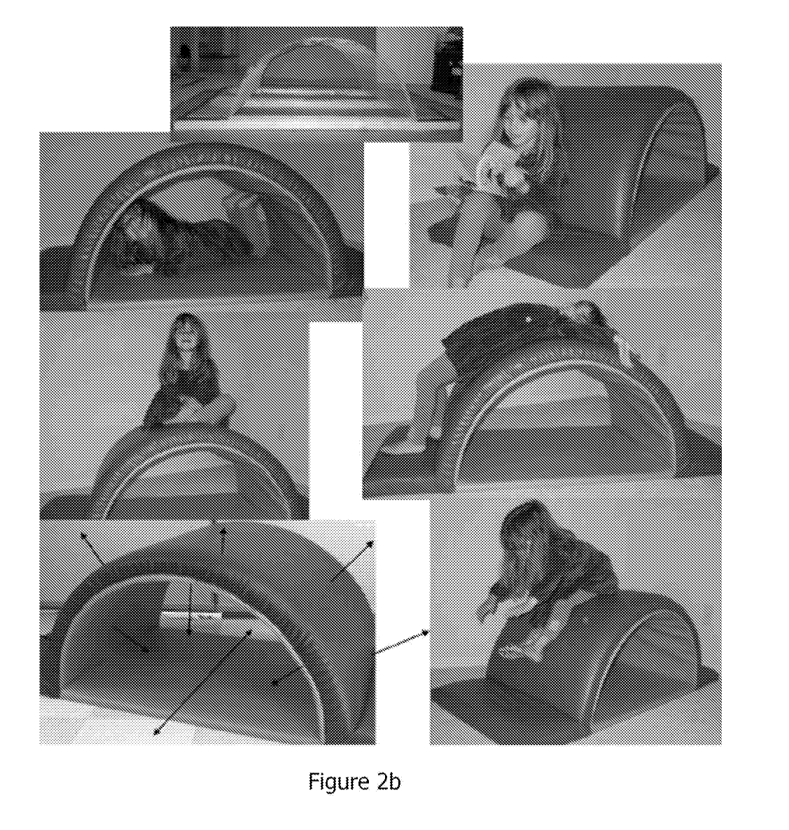

FIGS. 2a-b show a bridge/tunnel structure. Structure of bent wood with a fiberglass overlay. Padded outside with 2 inches foam, inside with 1 inch foam. Fabric covering is perforated vinyl, width 21 inches, length 4 feet, height 20 inches.

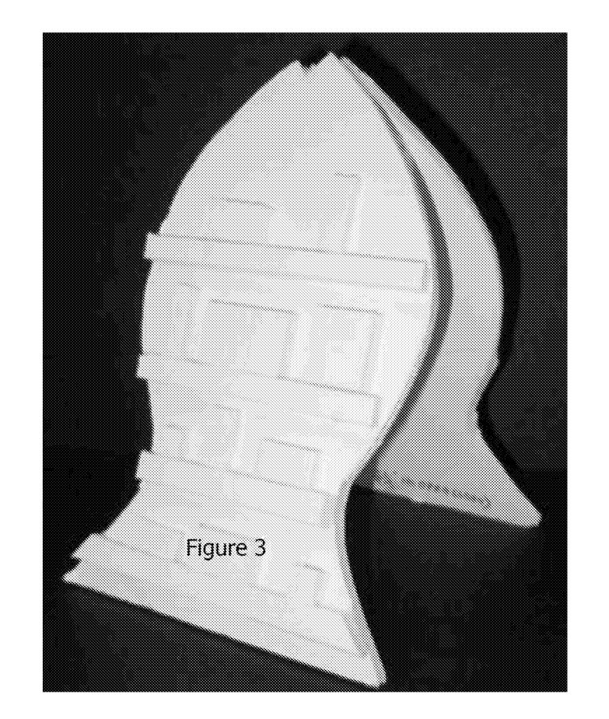

FIG. 3 shows a fish shaped book shelf. The wood structure is covered in F-Sorb with a fabric covering. It is slanted to direct the unabsorbed sound at an angle toward the ceiling The center can be used as a tunnel

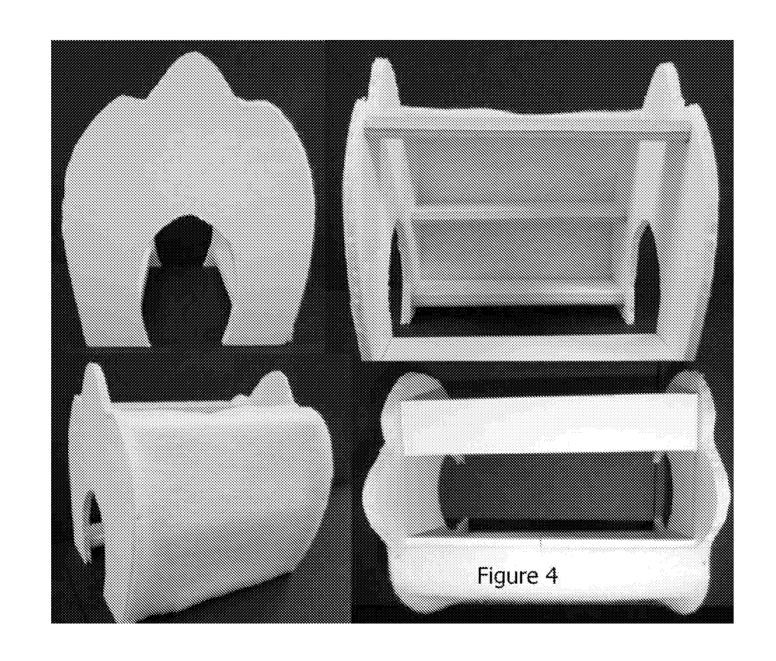

FIG. 4 shows a tunnel with interior toy shelf. The ends are structural with acoustical covering, while both sides are acoustical material. One of the interior sides has 2 shelves, the other has a very low bench for sitting or playing on. The shelves rest on support beams which hold the two structural ends together. The top is open to allow for noise inside to escape, while care givers can peak in. The shape is curved to diffuse classroom noise that is not absorbed. The interior width between the shelves is 3 feet. The overall height is 5.5 feet, the width are the widest part is 5 feet. (shown with only one side covered to allow an inside view.)

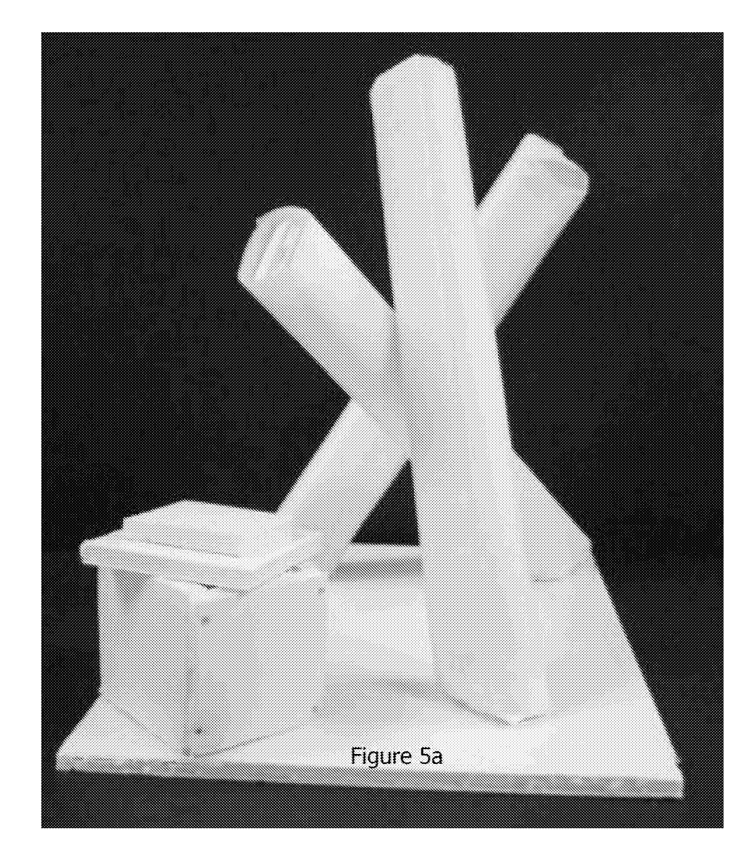

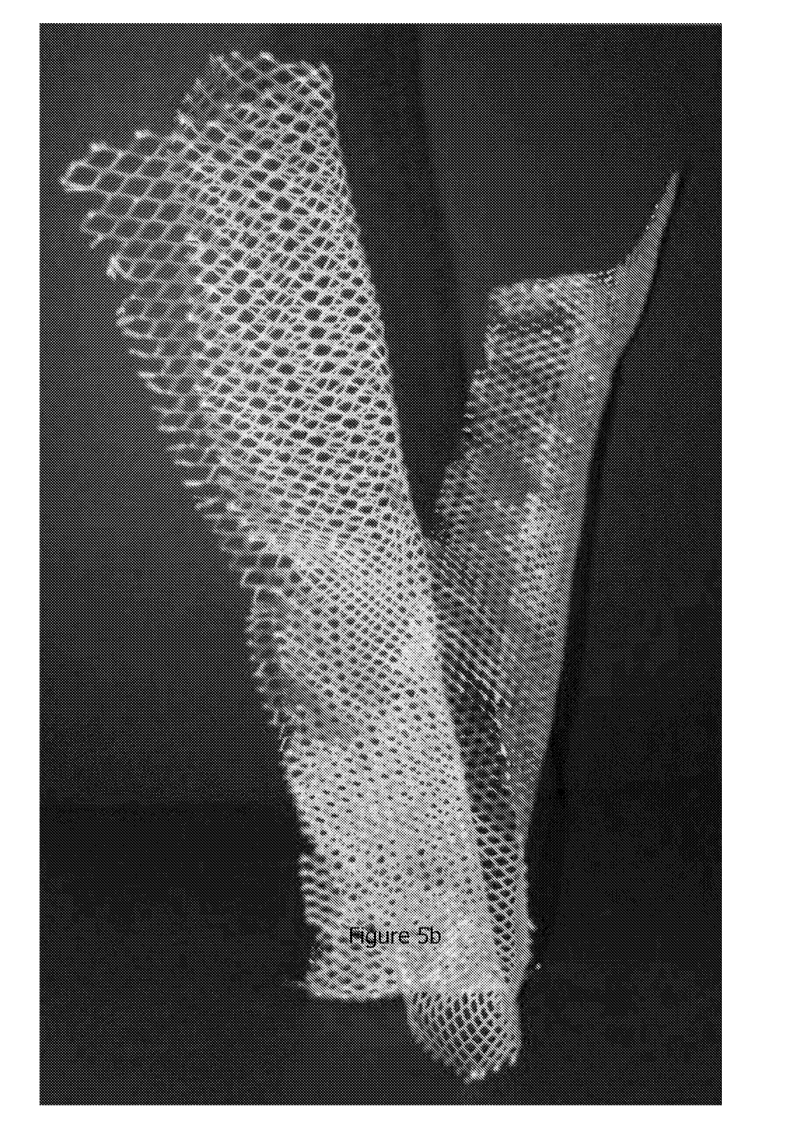

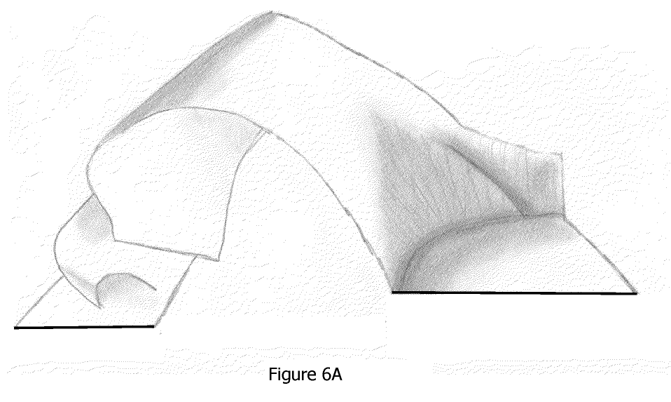

FIG. 5a shows leaning post. Angled oval beams reaching 5 to 6 foot high provide surfaces for leaning while listening, resting, reading and playing. The toy box lid doubles as a seating surface, play surface, or writing surface. When taken off, the under part of the lid is padded so it can be used as a comfortable lap table. The beams are padded with sound absorbing material, while the angle and shape divert noise. The toy box will be round to divert noise. The platform surface is covered with washable rubber flooring. Overall area: 6 feet×6 feet Beams: 5 to 6 feet high, 15 inches wide.

FIG. 5b shows a bendable sculpture. The bottom 2 feet 5 inches is structural and fixed in place. The top is bendable to be repositioned by the user. The lower area is padded, the top bendable portion has a tackable surface on one beam, a mesh surface on the other. Overall height: 6 feet Base width: approximately 3 feet.

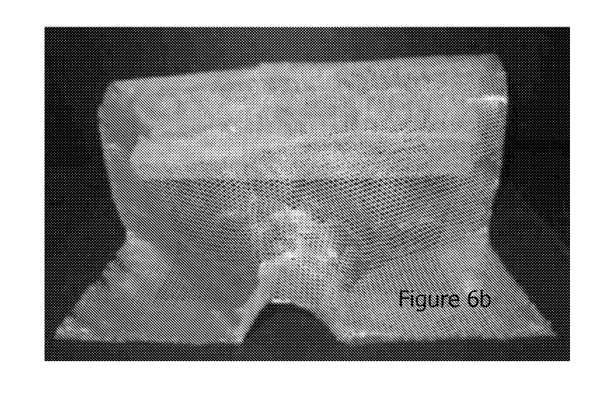

FIG. 6a is a combination of seat, tunnel, shelf or drawing surface, 4 feet×6 feet. FIG. 6b is a seating area. FIG. 6c is a shelf/low table area.

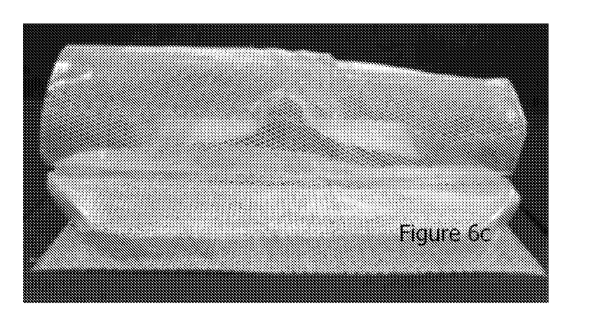

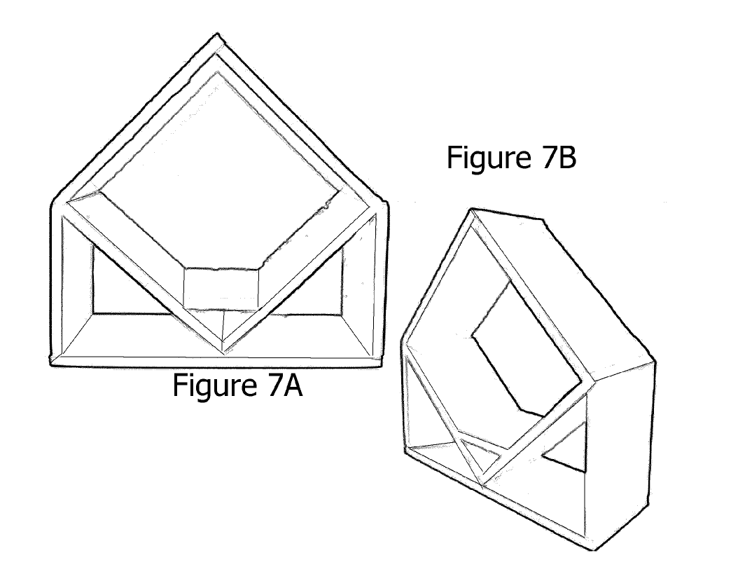

FIG. 7 is a listening center. The inside of the diamond is hard surface, so the child sitting inside can listen to music or stories. There is an optional speaker located in the top. The outer shell is covered with acoustical polyester (F-Sorb) to absorb classroom noise. The upper portion of the outer diamond shape reflects sound that is not absorbed at an upward angle. The interior reflects the sound toward the listener. The bottom, supporting area, can be used as storage or more cave like seating for smaller children. The upper diamond can seat two children.

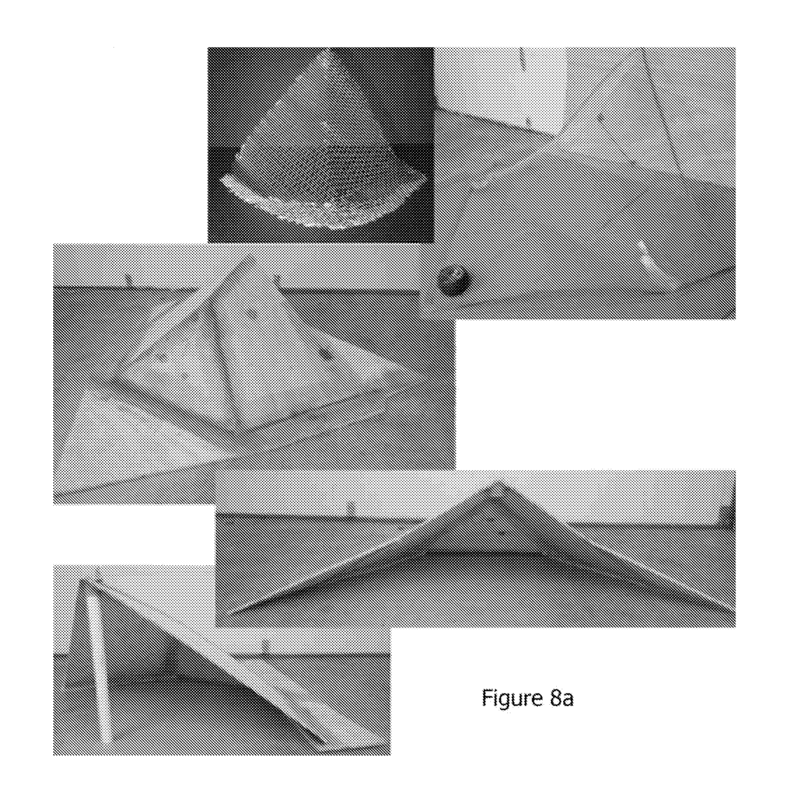

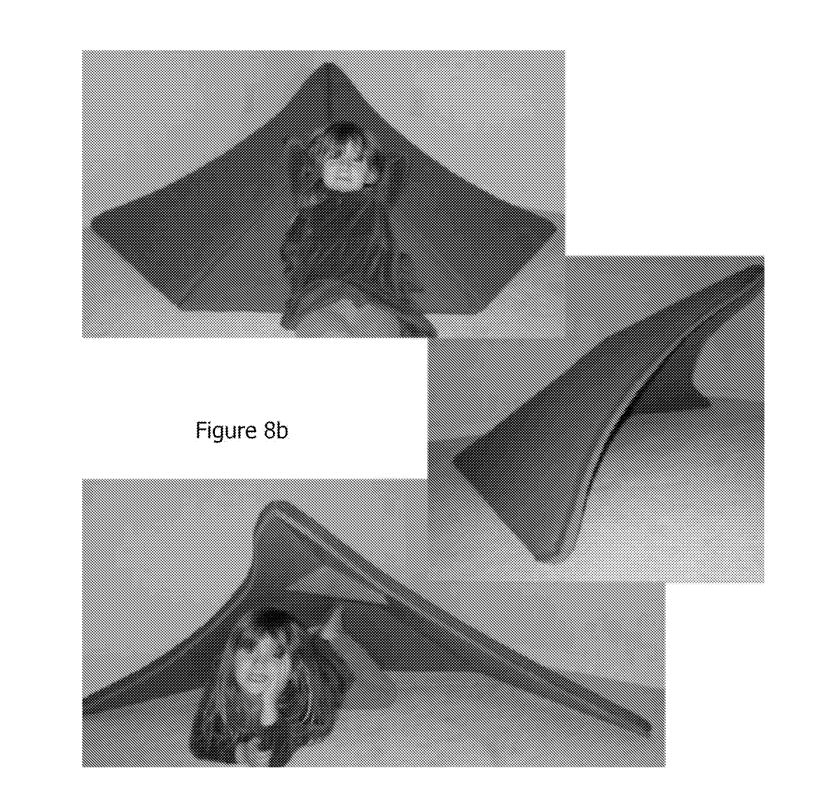

FIGS. 8a-b show a stealth chair/cave structure, to be constructed of aluminum, wood, plastic or fiberglass with or without padding.

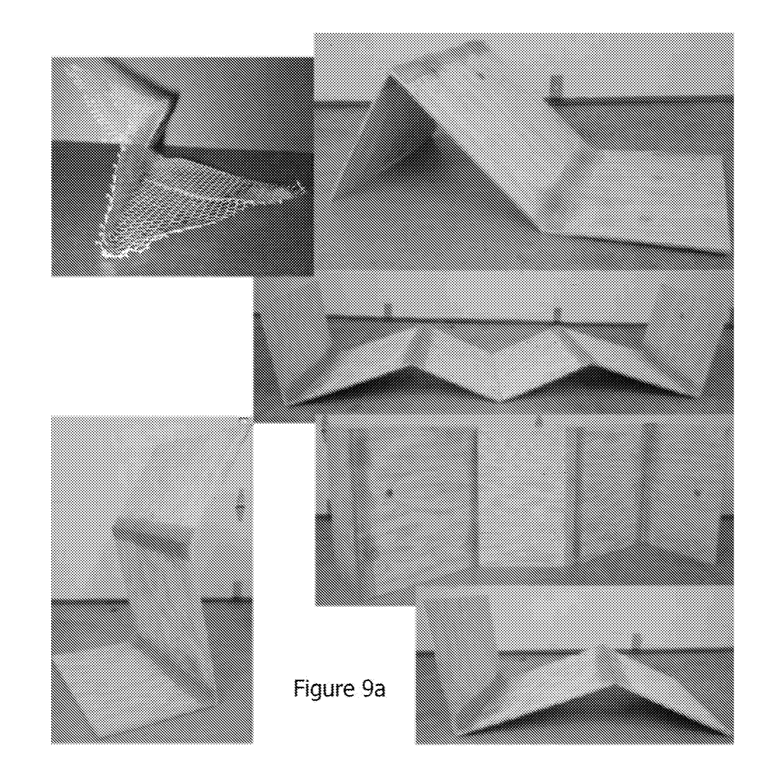

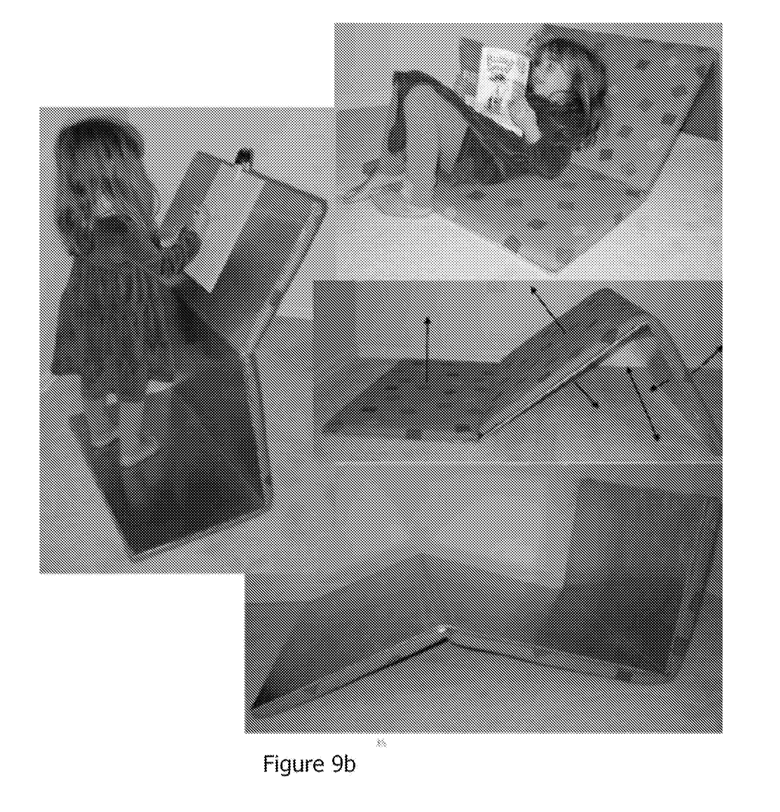

FIGS. 9a-b show a multifunctional zigzag chair, to be constructed of aluminum, wood, plastic or fiberglass with or without padding.

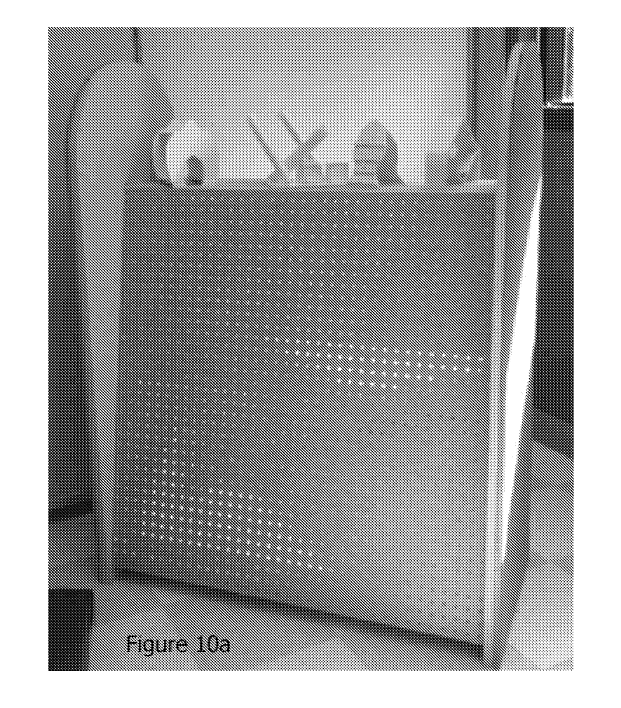

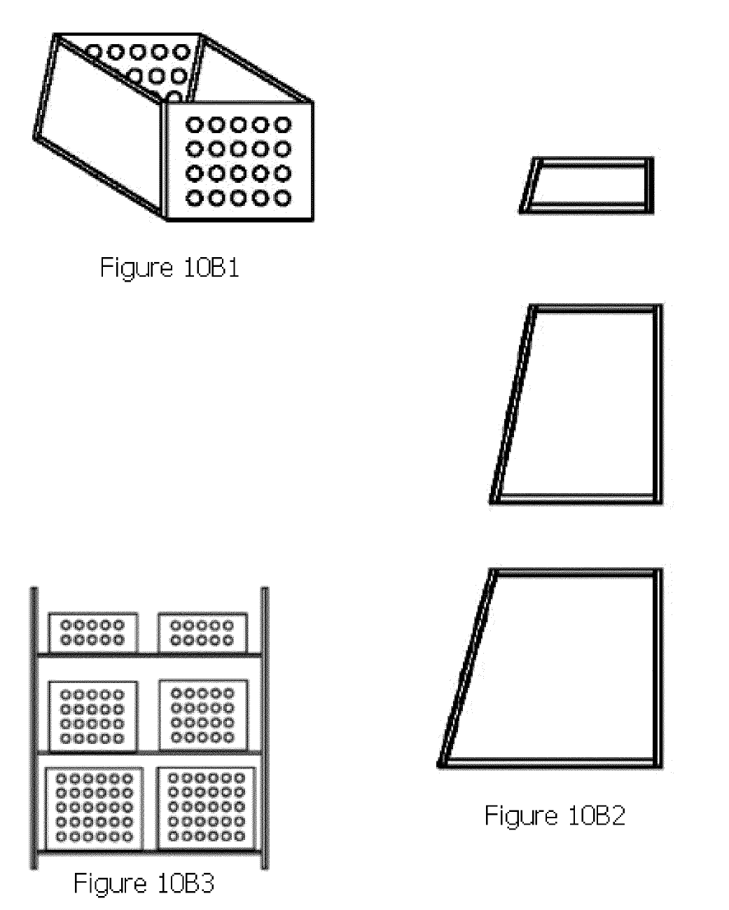

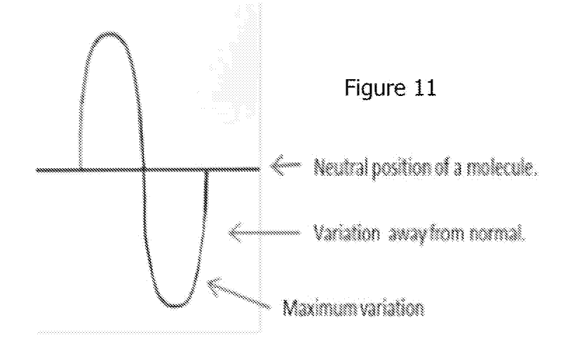

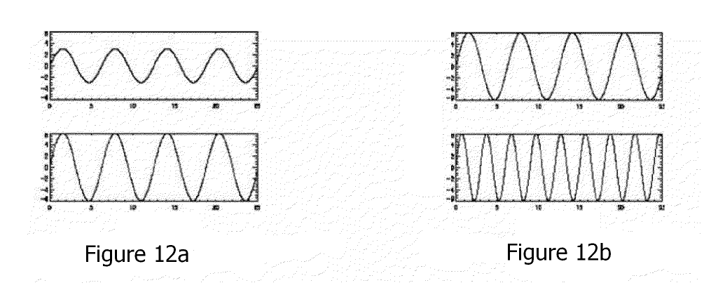

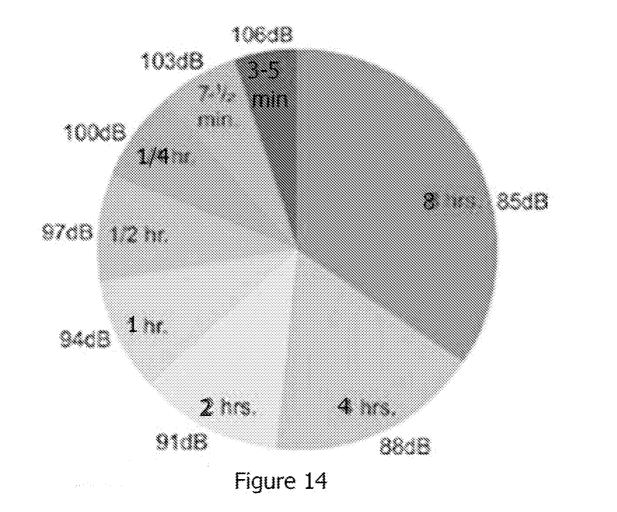

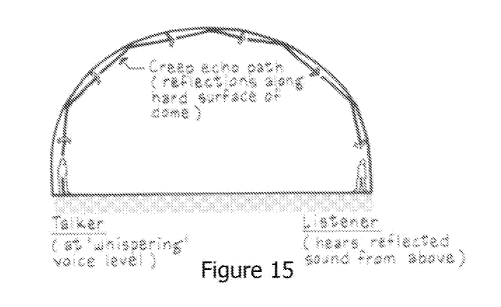

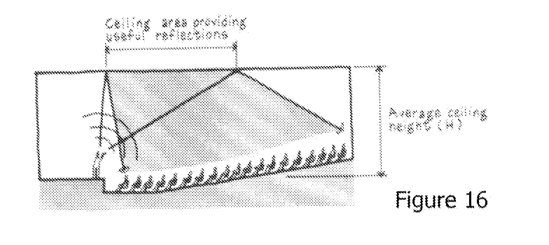

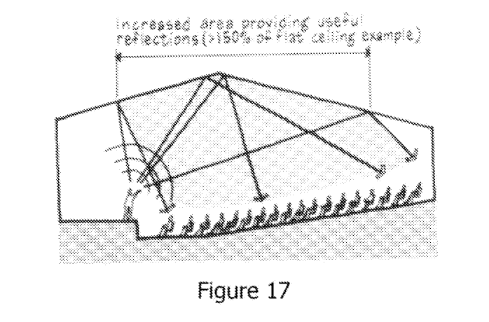

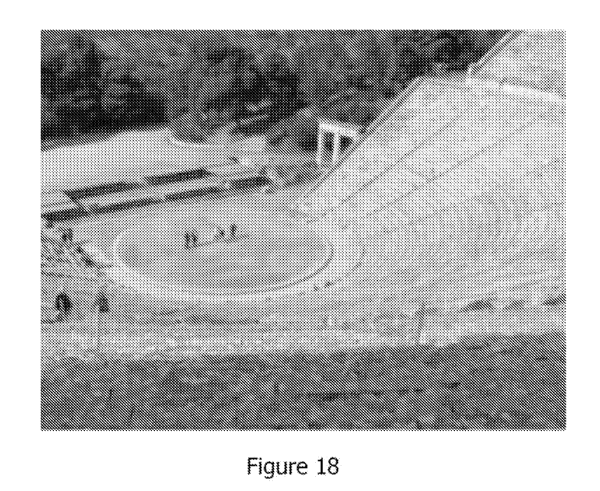

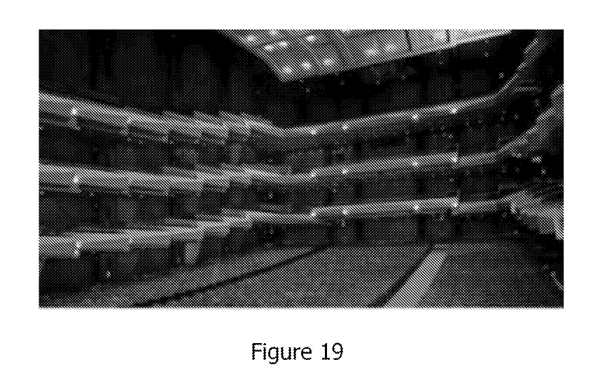

FIGS. 10a-b show a toy shelf. The flat, angled back of peg board allows sound to travel through and deflect at an upward angle. The back can also be constructed of various materials. Sides are fabric covered Micor or the like for sound absorption, and also doubles as a bulletin board. Curved side tops disperse sound. Angle back bins with perforated front and backs are made to fit the toy shelf. Front and back are perforated, sides are solid. The angled back makes the best use of space on the angled back toy shelf. The perforations in the bins allows the noise in the area to flow through the bins. Some noise will be trapped inside, bouncing around and dissipating within the contents of the bin. Some will flow through and out the back. The bins can be manufactured using wood, various colors of recycled plastic or acrylic. Sizes will vary depending on the shelving unit ordered.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

I claim:

1. An article of acoustical furniture for use in a child day care center that lowers decibels, minimizes, absorbs, deflects, or aims sound, is suitable for use by all ages, is washable, stable, sturdy and safe for use by children.
